(19) United States
(12) Patent Application Publication
(10) Pub. No.: US 2013/0087023 A1
(43) Pub. Date: Apr. 11, 2013

(54) CONTROLLED FORCE DRIVE AND RELATED METHOD OF USE

(71) Applicant: NATIONAL NAIL CORP., Grand Rapids, MI (US)

(72) Inventor: Roger A. Vandenberg, Hudsonville, MI (US)

(73) Assignee: NATIONAL NAIL CORP., Grand Rapids, MI (US)

(21) Appl. No.: 13/630,230

(22) Filed: Sep. 28, 2012

Related U.S. Application Data
(60) Provisional application No. 61/544,048, filed on Oct. 6, 2011.

(51) Int. Cl. B25B 23/14

(52) U.S. Cl. 81/467

(57) ABSTRACT

A controlled force drive element, for use with a rotational power tool, including a spring loaded drive line that exerts a preselected force on a fastener engaged by a drive head as the drive head rotates and advances the fastener. The drive element includes a primary drive body including a chuck connector to join with a chuck of a tool, an optional secondary drive body, a tool bit and a biasing element. The secondary body and tool bit are reciprocally joined with the primary drive body. A biasing element is joined with the primary drive body and/or the tool bit, and configured to compress under a force as the drive head engages the fastener to allow the tool bit and the drive head to retract toward the primary drive body. The biasing element is disposed along the spring loaded drive line between the chuck connector and the drive head.

### BACKGROUND OF THE INVENTION

The present invention relates to rotating drive elements, and more particularly, to a drive that applies a preselected force to a fastener as the fastener is advanced and rotated, and a related method of use.

There are a variety of commercially available fasteners designed to fasten a work piece, such as wooden board or composite element, to a substrate, such as a subfloor, joist or other underlying support structure. Most fasteners are in the form of extruded screws that include a drive feature, for example, a phillips, hex or star drive head, and a threaded portion which enables the fastener to be advanced into the work piece.

Typically, such fasteners are advanced into the work piece with power tools, such as cordless drills, battery operated drills, or electric power drills and/or power screwdrivers. In some cases, when using such power tools, too much or too little force is exerted by the user on the fastener as it is advanced into the work piece. In turn, this can cause the fastener to advance too quickly or too slowly into the work piece. Where the substrate is wood, a composite, or material that is prone to splitting, cracking, deforming or bulging near the fastener as it is advanced, improper force application can present an issue. This issue is exacerbated where the fastener is advanced through a corner or a thin section of the work piece.

Thus, without proper management of force application, the use of certain power tools to drive fasteners into work pieces can undesirably damage those work pieces.

Further, in some other rotational applications, such as boring, drilling, reaming, swaging, and the like, an improper application of force through a drive element to a work piece can result in undesirable damage to the work piece and/or the drive element.

### SUMMARY OF THE INVENTION

A drive element adapted to exert controlled force application to a fastener advanced with the drive element, or to a drive head during rotation, is provided.

In one embodiment, the fastener drive element is configured to be selectively joined with a rotational power tool, such as a cordless drill, an electric drill, a power screwdriver, or other tool, and rotated to exert a relatively constant force on a fastener being advanced or driven by the drive element and tool.

In another embodiment, the fastener drive element can include a spring loaded drive line, in which a drive head including a drive feature, which interfaces with a fastener head to exert a rotational force or a moment thereon, is operably coupled to a biasing element, which is further operably coupled to a chuck connector. In the spring loaded drive line, the biasing element, that is, the spring, can be disposed between the chuck connector and the drive feature of the tool bit during the entire driving operation of the fastener being installed. The chuck connector can be configured to connect to a chuck or other connection element of a power tool.

In still another embodiment, the drive head is reciprocally mounted relative to the chuck connector and/or power tool when a force is exerted through the power tool and the spring loaded drive line. The biasing element can compress and extend, depending on the force applied through the fastener drive element directly through the chuck connector to the biasing element to the drive feature of the tool bit. Generally, the chuck connector, when under force, moves toward the drive head, and vice versa, and compresses the biasing element along the spring loaded drive line. The precise amount of force applied can be output to a user via an optional force indicating element to inform the user of the force applied and/or that a preselected force has been achieved. This preselected force can correspond to a force suitable for advancing the fastener into a work piece at a desired advancement rate that avoids damage to the work piece.

In even another embodiment, the fastener drive element can include a tool bit including the drive head. The drive head can include a phillips, hex, star, square, triangular or other conventional drive depending on the drive feature of the relative fastener to be driven. The tool bit also can include a shaft having a connector end.

In a further embodiment, the fastener drive element can include a housing or a sleeve. The biasing element can be at least partially housed within the housing. The fastener drive element can also include a connector body. The connector body can be at least partially reciprocally mounted in the housing as well.

In still a further embodiment, the biasing element can be at least partially housed within the housing, and can be configured to oppose movement of the connector body within the housing.

In yet a further embodiment, the connector body can be restrained within the housing and can define a socket which receives the connector end of the tool bit to connect the tool bit to the connector body, and operably couple the tool bit to the remainder of the fastener drive element.

In even a further embodiment, the biasing element can be in the form of a spring that is configured to urge the connector body into an extended position, yet allow the connector body to retract to a retracted position when a certain preselected force is exerted through the spring loaded drive line of the drive element on a fastener.

In even yet a further embodiment, the biasing element can be in the form of magnets that repel and/or attract one another. One magnet can be associated with the primary body, and another associated with the connector body and/or tool bit. The magnetic forces of the magnets can operate to allow the connector body and/or tool bit to retract in a controlled manner under an external force, yet extend the connector body and/or tool bit to an extended mode when the external force is removed, via magnetic forces of the magnets.

In another, further embodiment, the fastener drive element can include a force indicating element, for example an indicia or marking, that provides a visual, tactile and/or audible signal or output to indicate the fastener is being driven under one or more preselected forces or other forces. Optionally, the force indicating element can include a primary force indicating element that corresponds to a force and/or range of force with which the fastener can be driven with the fastener drive element in a suitable manner without damaging the work piece with the fastener.

In yet another, further embodiment, the fastener drive element can include a rotational slip element. This rotational slip element can include a groove defined in the housing and/or the connector body and a connector pin. The groove can be transverse to a slot within which the connector pin is registered and slides. When too much force, for example, an excessive force, is applied to the drive head, the connector pin enters the groove, which causes the housing and connector body to rotate relative to one another. Accordingly, the drive head is no longer rotated by the fastener drive element. This can prevent a fastener coupled to the drive head from being advanced too quickly into a substrate, which might damage the substrate.

In still another, further embodiment, the drive element can include or be joined with at least one of a boring, drilling, reaming, swaging or other rotating drive head, bit or component. In use, the drive element can apply a controlled preselected force as the rotational operation is performed.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a side view of a current embodiment of a fastener drive element in an extended mode;

FIG. 2 is a second side view of the fastener drive element in a retracted mode;

FIG. 3 is a sectional view of the drive fastener drive element;

FIG. 4 is a perspective view of the fastener drive element, installed on a power tool, initially engaging a fastener;

FIG. 5 is a perspective view of the fastener drive feature as a preselected force is exerted on the advancing fastener;

FIG. 6 is a sectional view of a first alternative embodiment of the fastener drive element;

FIG. 7 is a sectional view of a second alternative embodiment of the fastener drive element;

FIG. 8 is a sectional view of a third alternative embodiment of the fastener drive element;

FIG. 9 is a side partial sectional view of a fourth alternative embodiment of the fastener drive element in a retracted mode under a preselected force;

FIG. 10 is a side perspective view of the fourth alternative embodiment of the fastener drive element free-spinning under a first excessive force; and

FIG. 11 is a side perspective view of the fourth alternative embodiment of the fastener drive element under a second excessive force.

### DETAILED DESCRIPTION OF THE CURRENT EMBODIMENTS

### I. Overview

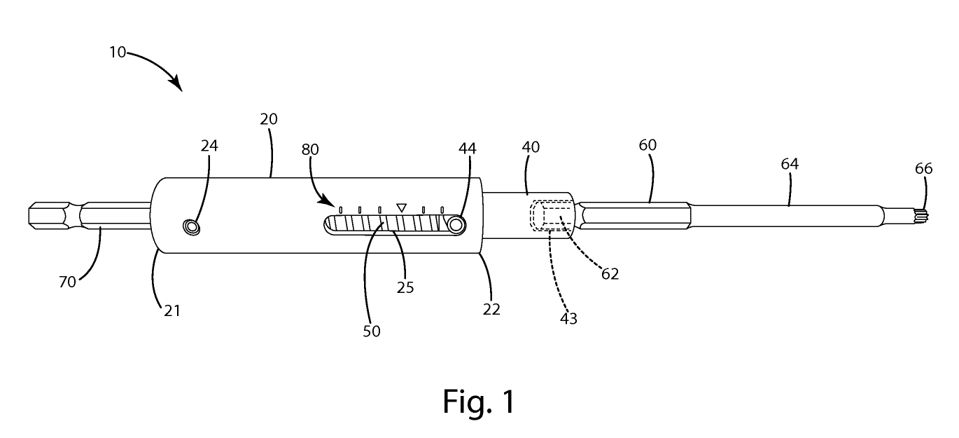

A current embodiment of the fastener drive element is illustrated in FIGS. 1-5 and generally designated 10. The fastener drive element 10 generally includes a primary drive body, for example, a sleeve or housing 20 to which a secondary drive body, for example, connector body 40 is reciprocally joined. A biasing element 50 engages the connector body 40 and enables it to reciprocate when force is exerted on an associated tool bit 60. The housing is joined with a chuck connector 70, or chuck stub, that joins the fastener drive element 10 with a power tool 100.

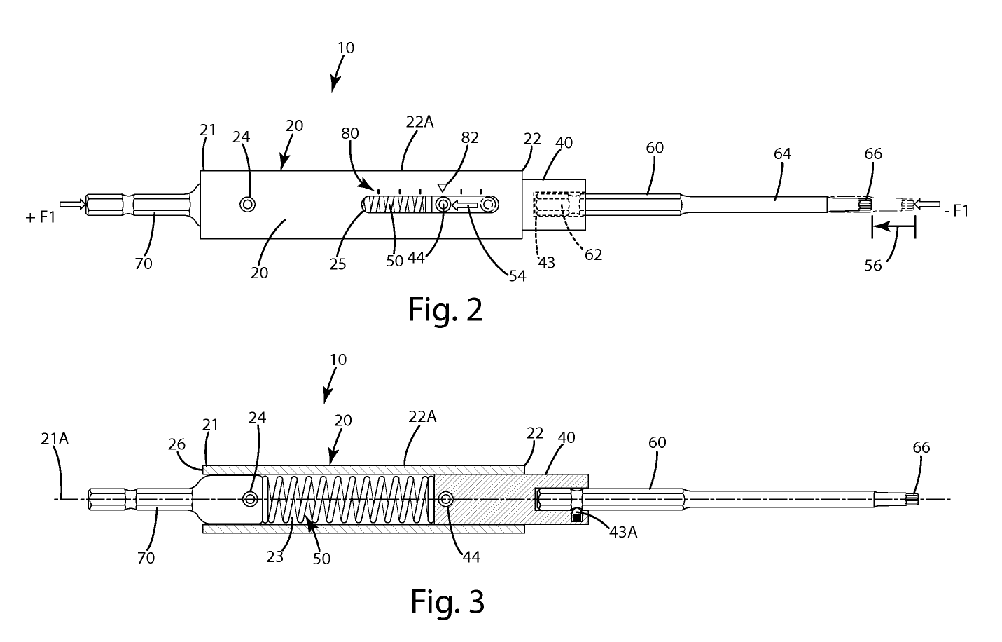

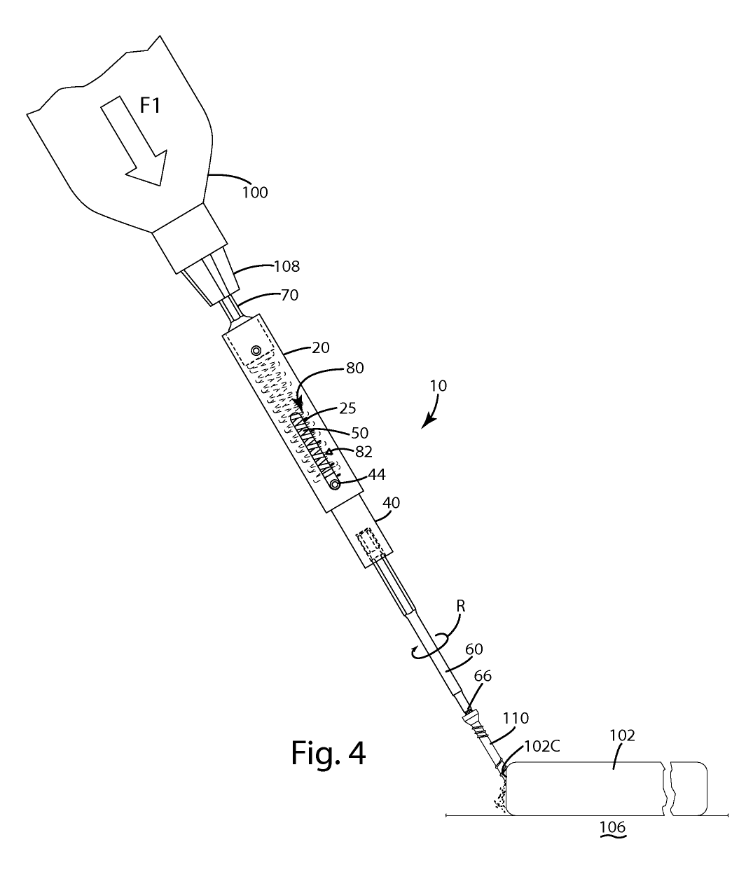

In use, the tool bit 60 is operably coupled to the connector body 40. The chuck connector 70 is operably coupled to a power tool 100. The fastener drive element 10 is aligned with a fastener 110 so that the drive head 66 directly engages the fastener, optionally distal from the connector body 40 and housing 20. As shown in FIGS. 2 and 4, when the power tool is activated, it exerts a moment or rotation R on the fastener 110. A force F1 and/or +F1 is exerted through the power tool, through the drive line and to the fastener 110. As the force is applied, it can be adjusted to a preselected force, i.e., from an initial force F1 and/or +F1 of about 2 pounds to about 10 pounds, to a preselected force, optionally, about 3 to about 25 pounds, further optionally, about 4 to about 15 pounds, or more or less depending on the application, work piece and fastener. As the force exerted on the fastener 110 changes from F1 and/or +F1 to F2, the connector body 40 compresses the biasing element 50. The precise amount of compression can correspond to the desired preselected force F2.

The preselected force can correspond to the force that enables the fastener to be advanced as it is rotated into the work piece 102 and/or substrate 106, without substantially damaging the work piece and/or the substrate, for example, without splitting, cracking, deforming or bulging these items adjacent the area where the fastener 110 is advanced.

The fastener drive element 10 can also include a force indicating element 80. When the force exerted through the fastener drive element 10 corresponds to a preselected force F2, a portion of the fastener drive element 10, for example, the housing pin 44, also referred to as a connector pin, or other component, can align with a primary force indicating element 82 to visually indicate to a user that the preselected force F2 has been achieved, and that the fastener 110 can be advanced with that force being applied, generally without damaging the work piece and/or substrate. Optionally, the drive element can provide a level of applied force monitoring with the foregoing features.

Although the drive element herein is described in connection with advancing a fastener, it can be used in connection with boring, drilling, reaming, swaging or other rotational operations. In such applications, the tool bit can be a respective boring, drilling, reaming, swaging or other drive head, bit or component. In use, the drive element can apply a controlled, preselected force as the rotational operation is performed, and/or can provide force monitoring during such rotation or other linear operation. Optionally, the drive element can be further used in applications where the drive element is not rotated.

### II. Construction

The components of the fastener drive element now will be described in further detail with reference to FIGS. 1-5. As noted above, the fastener drive element 10 can include a primary drive body, shown as a housing 20 operably coupled to a secondary drive body, shown as a connector body 20 which is operably coupled to a tool bit 60.

The housing 20 can include a first end 21 and a second end 22. The primary drive body or housing can include an exterior surface 22A, which can extend from the first end toward the second end. A chuck connector 70 or chuck stub can be joined with the first end 21. The chuck connector 70 can be of a hexagonal cross section, but of course, alternatively, it can be of a cylindrical, square or other configuration, depending on the intended chuck to which the fastener drive element is to be attached. Generally, the chuck connector 70 can extend sufficiently from the first end 21 of the housing 20 so that it can be interfit within a chuck 108 of a power tool 100 (FIG. 4), a hand tool, or some other tool, depending on the application.

The primary drive body 20 optionally can include a longitudinal axis 21A, shown in FIG. 3. The longitudinal axis also can be the axis of rotation for the fastener drive element if desired. Generally, the different components of the fastener drive element can all be centered on the longitudinal axis. Further, the connector body 40 and/or tool bit 60 can be reciprocally mounted to the primary drive body, moving generally from an extended mode to a retracted mode when a preselected force is applied to the fastener drive element during a fastener driving operation as described below.

The chuck connector 70 can be integrally formed with the housing 20. For example, the chuck connector can be molded with the housing directly or otherwise machined from a single piece of material. Alternatively, the chuck connector 70 and housing 20 can be separate components so that these elements can be separated from one another. For example, as shown in FIG. 3, the end 21 of the housing 20 can define a hole or opening 26 into which the chuck connector 70 is placed. The chuck connector can extend into the internal bore 23 defined by the housing 20. A connector housing pin 24 can extend through a portion of the housing 20 as well as an end of the chuck connector 70 opposite the end of the chuck connector 70 that is joined with the chuck 108. This chuck housing pin 24 can be a roll formed pin or another type of pin. Alternatively, the pin 24 can be in the form of a fastener so that the chuck connector 70 can be removeably attached to the housing 20 and/or the chuck connector can be removed to service or replace the biasing element 50. Different sized chuck connectors 70 can be replaced for one another to fit different size chucks in power tools, depending on the application.

As mentioned above, the housing 20 can define an internal bore as shown in FIG. 3. Generally, the bore 23 can extend from the first end 21 to the second end 22. The internal bore 23 generally can house a portion of the biasing element 50. The bore 23 can also house at least a portion of the connector body 40. The internal bore as shown can be in the form of a cylindrical bore, however, other cross sectional configurations can be used or substituted therefor, depending on the application.

As shown in FIGS. 1 and 2, the housing 20 also can define a housing pin slot 25. This housing pin slot 25 can extend along a portion of the housing 20 generally adjacent the connector body 40. Housing pin slot 25 can effectively journal a connector pin 44 that extends through a portion of the slot, as well at least a portion of the connector body 40. The connector pin can be registered within the slot. Generally, the connector pin 44 can attach the connector body 40 to the housing 20 so that the body and housing are substantially permanently attached to one another, but in a relative sliding and/or telescoping configuration. Of course, if desired, the connector pin 44 can be replaced with a fastener that can be removed, thereby allowing the connector body 40 to be removed. Optionally, in such a case, the connector body 40 can be removed so that the spring 50 therein can be replaced or interchanged with a different spring, for example, a different spring having a different compressive force suitable for a particular fastener being driven by the fastener drive element 10. The connector body also can be removable so that the housing can be cleaned and/or lubricated.

As shown in FIGS. 2 and 4, the slot 25 can be of an elongated construction, which again allows the connector pin 44 to move within it. This movement can be effected by the biasing element 50 being compressed within the internal bore. Such compression can occur when a force is exerted on the fastener drive element 10 so that the restoring force of the biasing element is overcome, thereby enabling the biasing element to compress a predetermined amount.

The housing 20 can include a force indicating element 80. This force indicating element 80 can be in the form of graduated markings or indicia, optionally on the exterior of the housing or some other component of the drive element, that correspond to the amount of force exerted on a fastener 110 which is driven by the drive head 66, or generally by the tool bit 60. The force indicating element 80 can include a primary force indicating element 82, which can be a marking or other highlighted indicia that enable a user to visually identify when the preselected force is achieved. If desired, the force indicating element 80 can include numbers or letters that correspond directly to the force applied through the fastener drive element 10. As illustrated, the force indicating element can include the pin 44 disposed in the slot and a primary force indicating element, in the form of indicia 82 disposed on the housing.

In the current embodiment, the preselected force can be in a range of about 5 to about 40 pounds, further optionally about 10 to about 30 pounds, even further optionally about 4 to about 15 pounds. Of course, depending on the particular work piece into which the fastener 110 is driven, the particular forces can be varied. For example, with a more dense material or hardwood, the preselected force can be greater than those for a less dense material or soft wood.

As shown, the biasing element 50 can be in the form of a coil spring. This coil spring can be replaced for any other type of biasing element, for example, an elastomeric plug, extended leaf spring or other material capable of resisting a force applied through the fastener drive element 10.

If desired, the drive element, and more particularly, the biasing element 50 can be preloaded to compress the biasing element slightly. For example, the biasing element can be preloaded so that it compresses slightly under optionally about 1 to about 8 pounds, further optionally about 2 to about 6 pounds, and even further optionally about 4 pounds.

Returning to the current embodiment of FIGS. 1-3, the fastener drive element 10 can include a connector body 40 that is at least partially mounted within the internal bore 23 of the housing 20. The connector body 40 can be reciprocally mounted in the housing and biased to an extended position as shown in FIG. 1 via the biasing element 50.

In FIG. 1, the connector body 40 and the fastener drive element 10 are in an extended mode, in which the biasing element 50 has fully or substantially extended the connector element 40 and thus the tool bit 60. As shown in FIG. 2, when positive force +F1 is exerted by a power tool on the fastener drive element 10, an opposing force −F1 is exerted through a driven fastener to the tool bit 60. Upon such force application, the biasing tool bit 60 and connector body 40 reciprocate toward the primary drive body, optionally at least partially within the internal bore 23 of the housing 20. This is illustrated by the movement indicated by the arrows 54 and 56 in FIG. 2. As shown there, the connector pin 44 moves within the housing pin slot 25 in the direction of the arrow 54. Likewise, because the connector pin 44 is connected to the connector body 40, and that is connected to the tool bit 60, which includes the drive head 66, that drive head 66 moves toward the housing 20 as the force is applied. Because the drive head 66, moves with the tool bit 60, the drive head 66 also moves a preselected distance 56 toward the housing during a fastener advancing operation.

Optionally, the connector body 40 and the associated tool bit 60 reciprocate and move toward the primary body, or generally the connector chuck, a preselected distance, equal to the preselected distance 56, when the biasing element compresses under a force as the drive head engages the fastener. That distance can be about ¼″, ½″, ¾″, 1″, 1¼″, 1½″, 1¾″, 2″ or other distances depending on the application, the biasing element, and the components of the element 10. Such preselected distance, however, can be greater than the distance that the tool bit might move due to slop, tolerances or slight ancillary movement between the socket of the secondary drive body or its retainer, and the tool bit as desired.

Generally, as noted above, when the positive and negative forces +F1, −F1 are applied, the fastener drive element 10 is undergoing rotation via a moment exerted on the chuck connector 70 by the power tool 100 to drive the fastener. Optionally the housing 20 in no way engages the fastener 110, rather it is the drive head 66 of the tool bit 60 that engages the fastener and it does so at a distance from the housing and/or primary drive body.

Referring to FIG. 2, the connector body 40 can define a socket 43 into which the end 62 of the tool bit 60 fits. The socket can include a retainer 43A, such as a detent, ball, spring, or magnet that holds the tool bit end 62 within it. The tool bit end 62 of the tool bit can be of a corresponding shape that corresponds to the end of the socket. As shown, the shape can be hexagonal, but of course other shapes can be substituted therefor. The tool bit 60 also can include a shaft 64 that extends from the end 62 to the drive head 66. The shaft can be of the same geometric configuration of the end 62, or can be of a cylindrical configuration as shown. Of course other configurations can be used as well. Optionally, the tool bit 60 can be magnetized to hold the fastener.

The drive head 66 of the tool bit as shown is in the shape of a Phillips head. This Phillips head can be replaced with any type of conventional drive, for example a flat screw drive, a hex drive, a star drive, a square drive, a triangular drive, or any other conventional drive that corresponds to the respective fastener desired to be advanced with the fastener drive element 10.

The different components of the fastener drive element 10 can be constructed from a variety of materials. While metals and alloys are suitable, other materials, such as composites, polymers, ceramics, and combinations thereof can be used, depending on the application.

The fastener 110 driven with the fastener drive element 10 can be any type of fastener. One suitable fastener for a particular application is disclosed in U.S. patent application Ser. No. 12/908,549 to VandenBerg, filed Oct. 20, 2010, which is hereby incorporated by reference in its entirety.

Optionally, the fastener drive element 10 as described herein is considered to have a spring loaded drive line, which generally refers to a fastener drive element that includes a chuck connector, which attaches directly to a power tool, and a drive head and/or drive feature that is located distal from the chuck connector. Between the drive head and the chuck connector a biasing element, such as the springs described herein, is positioned. When the spring loaded drive line is placed under a compressive force as the drive head and/or feature directly engages a fastener, the drive head and/or feature moves toward the chuck connector; however, its movement is at least partially restricted or controlled by the compression (or decompression) of the biasing element throughout all or at least a portion of the movement. Generally, that movement of the drive head and/or feature can be linear along the longitudinal axis. With the spring loaded drive line, the force exerted through the fastener drive element, and ultimately on the fastener can be controlled and/or varied by the compression of the biasing element that is interposed between the chuck connector and the drive head. As noted above, the applied force optionally can be monitored by a user so that a preselected force is maintained while advancing the fastener into a work piece.

### III. Method of Use

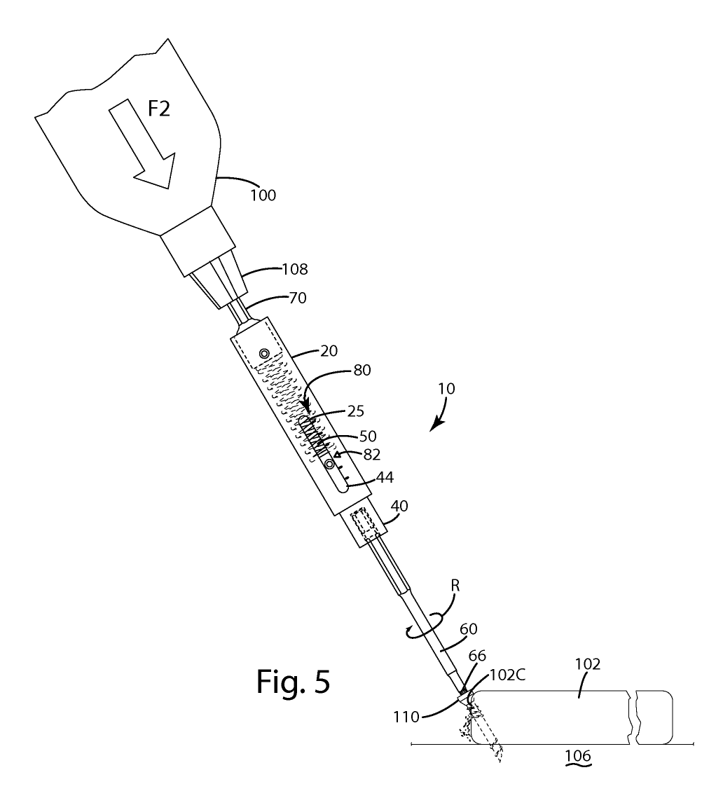

As shown in FIGS. 4 and 5, a method of using the fastener drive element 10 is presented. There, the fastener drive element is joined with a power tool 100 capable of exerting a rotational force or moment R on the fastener drive element 10. Generally, the chuck connector 70 can be inserted into the chuck 108 of the power tool 100. The chuck 108 can clampingly engage the chuck connector 70 to join the drive element 10 with the power tool 100. As shown in FIG. 4, the fastener drive element 10 is in the fully extended mode, that is, the biasing element 50 has extended the connector body 40 through its fully extended state. A tool bit 60 is operably coupled with the fastener drive element 10 so that the components generally are rotationally fixed relative to one another.

The drive head 66 of the tool bit 60 can be engaged directly with the head of the fastener 110. The fastener 110 can be placed adjacent a corner or side 102c of a work piece 102. Although shown in connection with a particular side angled screwing operation, as disclosed in U.S. application Ser. No. 12/908,549 to VandenBerg, the fastener and work piece orientation can be varied as desired, depending on the application. For example, the fastener 110 can be a conventional sharp tipped screw point, and can be generally advanced orthogonally or at some other angle into the surface of a work piece or substrate.

With the fastener positioned adjacent the corner and/or side 102c, an initial force F1 is exerted through the power tool 100 to begin the advancing operation of the fastener 110 into the work piece 102. The power tool 100 can be engaged to rotate the fastener drive element 10 in the direction of rotation R. Accordingly, the fastener 110 also rotates. As it rotates, the fastener bores and advances into the work piece 102. The user can adjust the amount of force from F1, as shown in FIG. 4, to F2 as shown in FIG. 5, to advance the fastener 110 as fast as possible to minimize the time for installation of the fastener, and yet to avoid damaging the work piece 102 in the manner described above.

As the force F2 is increased to and becomes the preselected force, the connector body 40 and the associated tool bit 60 reciprocate from the extended mode shown in FIG. 4 to the retracted mode, also referred to as a driving mode, shown in FIG. 5. This retraction of the connector body 40 into the housing 20 can be provided by the spring 50 compressing under the force F2. When the connector pin 44 aligns with the primary force indicating element 82 under the force F2, this indicates to a user that the preselected force suitable for advancing the fastener 110 has been achieved.

As the force F1 is increased to the force F2, the drive head 70, which engages the fastener 110, moves toward the housing 20 and more generally toward the chuck connector 70. Thus, the distance between these elements changes as the fastener 40 is advanced and the fastener drive element 10 rotates.

At this point, the user can cease exerting any additional force that may be detrimental to advancing of the fastener, and/or that may damage the board by advancing the fastener too quickly. The user can maintain the preselected force F2 (which can include a range of preselected forces) throughout the remainder of the advancing operation of the fastener.

Throughout the driving operation, the spring loaded drive line can maintain the biasing element 50 between the drive head 66 and the chuck 70, and more generally the power tool. Accordingly, the amount of force exerted through the drive line can be controlled. Of course, if more or less force is desired to advance the fastener 110 into the work piece 102, the user can review and monitor the force indicating element 80 and select the appropriate amount of force depending upon the positioning of the connector pin 44, or any other element used to gauge the movement of the connector body 40 relative to the housing 20, and thus the drive head 66 relative to the chuck connector 70.

After the fastener is sufficiently advanced into the work piece 102 and any underlying substrate 106 if applicable, the force F2 can be removed from the fastener drive element 10 in which case the connector body 40 is moved by the biasing element 50, returning to its extended mode. The drive head 66 can be disengaged from the head of the fastener 110. A user can install a new fastener on the drive head 66, position that new fastener adjacent work piece 102, and begin the operation above again. This process can be repeated multiple times until a sufficient number of fasteners have been advanced into a work piece to connect the work piece to a substrate, or install the fastener as desired.

### IV. First Alternative Embodiment

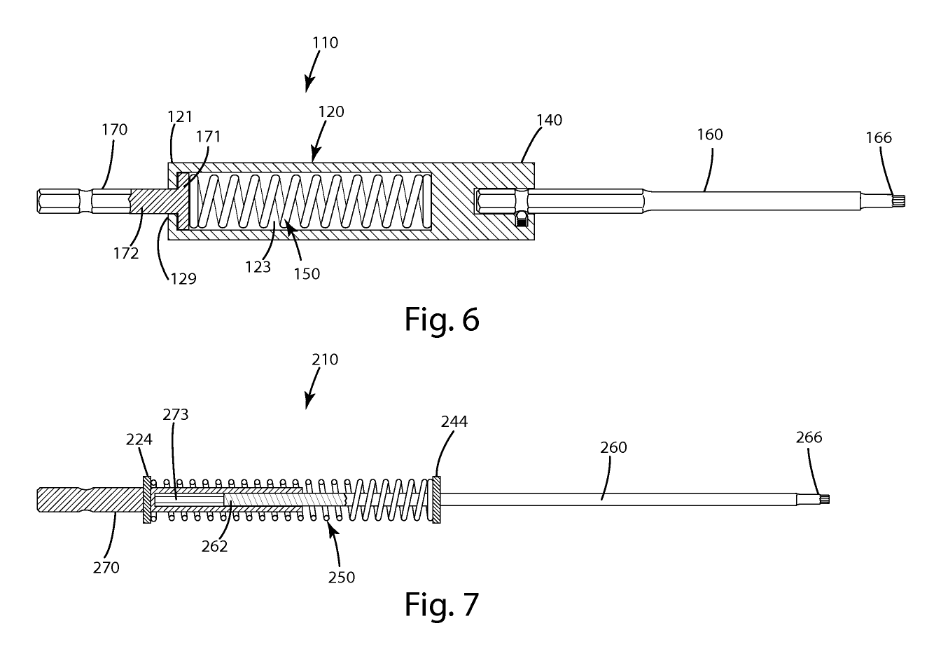

A first alternative embodiment of the fastener drive element is shown in FIG. 6 and generally designated 110. The fastener drive element 110 shown there is similar in construction and operation to the embodiments described above, with several exceptions. For example, the housing 120 and the connector body 140 are formed as an integral, monolithic, single-piece construction. Optionally, the connector body and the housing are rigidly and fixedly joined with one another. The tool bit 160 is joined with the connector body 140 in a socket as shown. A spring 150 is disposed in the internal bore 123 of the sleeve 120. The chuck connector 170, however, includes a chuck plate 171 that is moveably mounted within the internal bore 123 of the housing 120. The first end 121 of the housing is configured to enable a shaft 172 of the chuck connector 170 to reciprocate through an aperture 129 defined in the first end 121. The plate 171 engages the spring 150 directly. Generally, the chuck connector is engaged with the biasing element. The chuck connector 170 can reciprocate relative to the housing 120; however, the tool bit is still also considered to be reciprocally joined with the primary drive body. In this configuration, the fastener drive element 110 includes a spring loaded drive line that enables the drive head 166 to move relative to the chuck 170 and, generally for the tool bit 160 to reciprocate relative to the chuck 170.

### V. Second Alternative Embodiment

A second alternative embodiment of the fastener drive element is illustrated in FIG. 7 and generally designated 210. The fastener drive element shown there is similar in construction and operation to the embodiments described above with several exceptions. For example, the chuck connector 270 can be in an elongated form, and can define an internal bore 273. The chuck connector 270 also can include a chuck pin 224 that serves as a stop for the spring 250, which engages that pin. The tool bit 260 includes an end 262 that is at least partially mounted within the internal bore 273 of the chuck connector 270. The biasing element 250 extends generally from the chuck pin 224 to the tool bit pin 244. The ends of the spring can be welded or otherwise fastened to these pins, or to the respective chuck and tool bit near these pins. Of course, the pins can be eliminated and the spring can simply be welded or otherwise fastened directly to the chuck 270 and the tool bit 260. In this configuration, the fastener drive element also includes a spring loaded drive line which enables the drive head 266 to reciprocate or move relative to the chuck connector 270 when placed under a preselected force. The spring under force compresses a predetermined amount, depending on the application, to exert the preselected force on a fastener driven with the drive head 266.

### VI. Third Alternative Embodiment

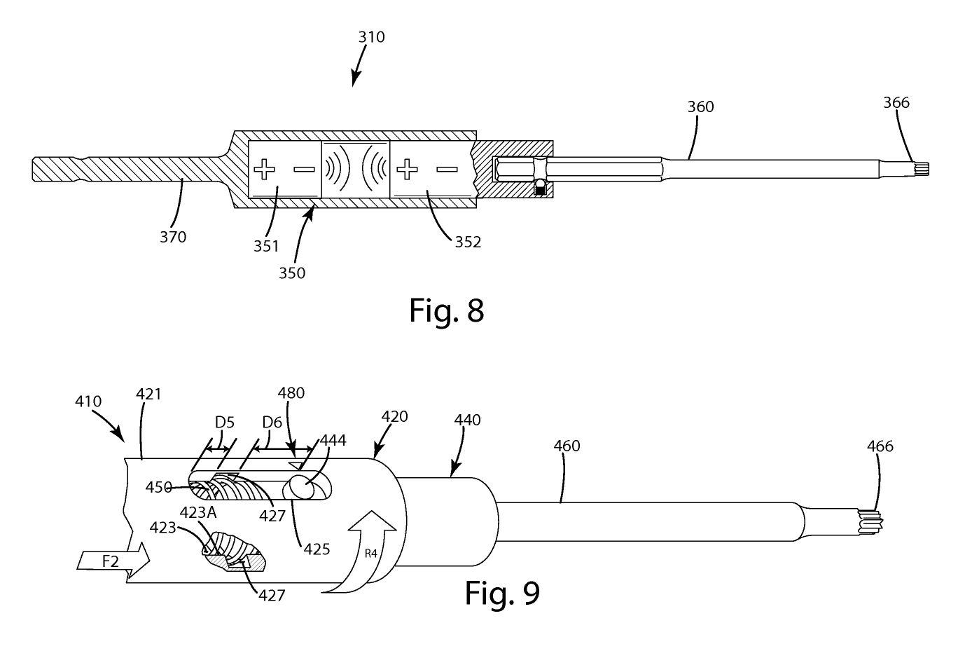

A third alternative embodiment of the fastener drive element is illustrated in FIG. 8 and generally designated 310. The fastener drive element shown there is similar in construction and operation to the embodiments described above with several exceptions. For example, in this embodiment, the fastener drive element 310 can include a biasing element in the form of opposing magnets 351 and 352. The magnets can be oppositely charged so that they generally repel one another. When an initial force is exerted on the tool bit 360, for example when advancing a fastener, the magnetic elements 351 and 352 can resist that force by their opposing magnetic forces. When the initial exerted force increases to meet or exceed a preselected force, that preselected force can overcome the opposing magnetic forces. As a result, the magnets can move closer to one another, or generally, the secondary drive body 352, tool bit 360 and/or drive head 366 can move from an extended position to a retracted position during a driving operation so that a fastener driven by the fastener drive element is driven under the preselected force.

### VII. Fourth Alternative Embodiment

A fourth alternative embodiment of the fastener drive element is illustrated in FIGS. 9-11 and generally designated 410. The fastener drive element as shown there is similar in construction and operation to the embodiments described above with several exceptions. For example, the fastener drive element 410 includes a primary body 420 and a secondary body 440, for example a housing and a connector body. The connector body 440 is attached to a tool bit 460 which includes a drive head 466, like those of the other embodiments herein. The housing 420 can define a slot 425 or other aperture similar in construction. Inside the slot, a connector pin 444 or fastener or other projection which is attached to or otherwise joined with the connector body 440 is registered. As with the other embodiments above, the connector body 440 can be reciprocally mounted relative to the housing 420. The connector pin 444 can maintain this registration and generally couple the connector body 440 with the housing 420. The housing or primary body 420 can also define a groove 427. This groove 427 can be in the form of a channel, a slot or a shoulder. Generally, the groove 427 is transverse to the slot 425, and optionally, perpendicular to the slot 425. If desired, the groove 427 can be offset at another angle, for example 5°, 10°, 15°, 20°, 25°, 30°, 40° and/or 45° from the slot 425. Further, although not shown, the slot 425 itself can be offset at some preselected angle for example 5°, 10°, 15°, 20°, 25°, 30°, 40° and/or 45° from a longitudinal axis of the fastener drive element 410.

Optionally, although not shown, the location of the pin, slot and grooves can be reversed. For example, the pin can be associated with the housing, and the slot and groove can be defined by the connector body.

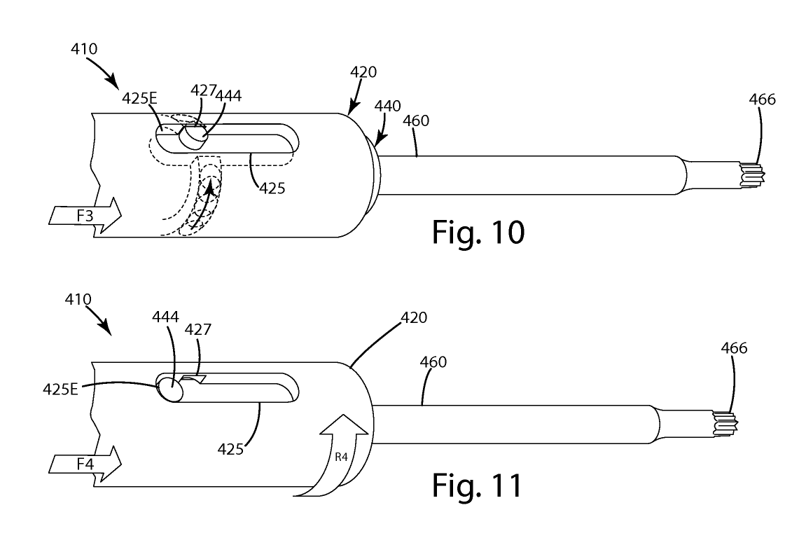

The groove 427 can generally be an annular groove extending around a circumference or internal surface 423A of the internal bore 423 of the housing 420. The groove 427 can be of a particular height and depth to enable the pin 444 to register within it and freely spin in a circumferential manner around the interior of the housing 420 when the fastener drive element is under certain forces. The groove 427 can be defined and in communication with the internal bore 423. It also can be mounted a preselected distance D5 from the uppermost end 425E of the slot 425. This distance D5 can be selected to that when an excessive force F3 as described below is exerted through the drive line of the fastener drive element 420, the pin 444 enters and freely spins in the groove 427 as shown in FIG. 10. This distance D5 can be about 1/32 inch to 1 inch, ⅛ inch to ¾ inch, ¼ inch to ½ inch, or any other distance as desired. The groove 427 also can be defined a preselected distance D6 beyond a location corresponding to the pin being disposed in the slot when a preselected force F2 is achieved. This distance D6 can be about ⅛ inch to 2 inches, ¼ inch to 1½ inches, ½ inch to 1 inch, or any other distance. The distance D6 also can be selected so that there is a margin of error between the application of the preselected force F2 and some first excessive force F3. Depending on the particular application, the groove 427 can be placed at virtually location along the length of the slot. The particular location can be dictated by the type of substrate or board into which a particular fastener is to be advanced using the fastener drive element 410, or other factors.

The internal bore 432 can be bounded by interior wall 432A of the housing 480. The groove 427 can be of a preselected depth sufficient to accommodate the uppermost end or tip of the connector pin 444 and allow it to rotate within the groove 427. It can also be of a preselected width so that the pin 444 freely rotates without catching or binding within the groove. Although shown as a generally squarish shaped or rectangular groove 427, that groove can be of other geometric shapes corresponding to the pin 444. For example, it can be a semicircular, triangular, polygonal or other shape which generally can accommodate the pin 444.

Further, the pin 444 can extend from the connector body 440 a preselected distance so that it will register within the groove 427 and freely spin under force and rotation. Although not shown, the pin can extend completely through the connector body 440 and out the opposite side of the connector body. In such a construction, the housing 420 can further define another slot on the opposite side of the housing, and that slot (not shown) as well can have a corresponding groove that is in communication with it.

A method of operation of the fastener drive element 410 of the fourth alternative embodiment is illustrated in FIGS. 9-11. In FIG. 9, the fastener drive element is being used to drive a fastener (not shown) with a force applied to the drive element to drive the fastener. This force F2 can be a preselected force for driving the fastener at a preselected rate into a substrate. Under such force F2, the pin 444 can register with the force indicating element 480 indicating to the user that the appropriate force is being used. Of course, the force indicating element 480 can be absent from the construction if desired as well.

While the user is applying the force F2, the line of sight with the force indicating element 480 sometimes can be obstructed. In such a case, the user might apply a first excessive force F3 which is greater than the preselected force and is ideal for driving the screw. Upon such excess in force application, the biasing element 450 compresses, and the connector body 440 and the associated connector pin 444 slide upward in the slot 425, toward the first end 421 of the housing. At some point, under the first excessive force F3, the connector pin 444 registers in the groove 427. Upon registration of the connector pin 427 within the groove 427, the housing 420 begins to freely spin or rotate relative to the connector body 440 and tool bit 460 within the groove 427. Generally, the pin 427 tracks in the groove during this rotation. When the housing, which again is attached to a power tool, begins to spin, the rotational forces R4 (FIG. 9) of the power tool (not shown) are no longer transferred to the connector body 440, nor the fastener. At this point, the user will notice the free spinning action of the fastener drive element 410, and can reduce force application from the first excessive force F3 to the preselected force F2. Upon the reduction in force, the biasing element 450 of the fastener drive element 410 will exert sufficient force to push the connector body 440 and thus re-register the connector pin 444 within the slot 425. This can eliminate the free spinning of the housing 420 relative to the connector body 440 so that the connector body 440 again rotates with the rotational force R4 in connection with the housing 420.

Optionally, as mentioned above the groove 427 can be located a preselected distance D5 from the end 425E from the slot 425. Thus, in some cases a user may need to exert a significant excessive force to advance a fastener into a particularly hard or dense substrate. With the construction shown in FIG. 11, the user can exert such a second excessive force F4. Upon such excessive force application, the biasing element 450 within the housing 420 is even further compressed under that second excessive force F4. When the second excessive force F4 exceeds the first excessive force F3 (FIG. 10), the pin 444 exits the groove 427 (FIG. 11) and enters into the slot end 425E. Upon registration with the slot end 425E, the connector body 440 and housing 420 are again rigidly connected to one another (and do not rotate relative to one another) via the connector pin 444 registered in the end 425E. Accordingly, the rotational force R4 (FIG. 11) is again transferred to the connector body 440, the tool bit 460, and the drive head 466. In such a case, the fastener drive element can again begin rotating the fastener and advance it through the dense, hard substrate or any obstructions in the way of the fastener.

After the fastener is through the substrate, the user can back off the second excessive force F4 to the first excessive force F3 or the preselected force F2 to either cease the application of the rotational force R4 or apply the rotational force R4 again and advance the fastener under the preselected force.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A controlled force drive element for use with a rotational power tool comprising:
a primary drive body including a chuck connector adapted to join with a chuck of a rotational power tool;
a secondary drive body reciprocally joined with the primary drive body;
a biasing element adapted to urge the secondary body to an extended mode, the biasing element compressible under a force to allow the secondary body to retract to a retracted mode while advancing a fastener with the drive element;
a tool bit joined with the secondary drive body including a drive head distal from the primary drive body;
wherein the biasing element is compressible under the force so that as the biasing element compresses, the drive head moves toward the primary drive body and the secondary drive body retracts to the retracted mode, and so that as the biasing element decompresses, the drive head moves away from the primary body and the secondary drive body extends to the extended mode;
wherein the primary drive body, secondary drive body, tool bit and drive head form a spring-loaded drive line that exerts a preselected force on a fastener engaged by the drive head as the drive head rotates and advances the fastener.

2. The controlled force drive element of claim 1 comprising a force indicating element, the force indicating element outputting at least one of audible and visual output to inform a user of at least one of a force applied to the fastener by the controlled force drive element and the preselected force, wherein the preselected force is suitable for advancing the fastener into a work piece at a desired advancement rate that avoids damage to the work piece.

3. The controlled force drive element of claim 1,
wherein the secondary drive body defines a socket,
wherein the tool bit includes a shaft,
wherein the shaft is disposed in the socket.

4. The controlled force drive element of claim 3 wherein the socket includes a retainer, the retainer engaging the tool bit to retain the tool bit in the socket and associated with the secondary drive body.

5. The controlled force drive element of claim 4 wherein the socket is distal from the biasing element and the primary drive body.

6. The controlled force drive element of claim 1,
wherein the primary drive body includes a housing,
wherein the secondary drive element includes a connector body,
wherein the connector body is slidably received within the housing.

7. The controlled force drive element of claim 6, comprising:
a pin joined with at least one of the housing and the connector body, and
a slot defined by the other of the at least one of the housing and the connector body,
wherein the pin is registered in the slot so as to constrain the movement of the connector body relative to the housing when the secondary drive body retracts to the retracted mode.

8. A controlled force drive element for use with a rotational power tool comprising:
a primary drive body including a chuck connector adapted to join with a chuck of a rotational power tool, the primary drive body including a longitudinal axis;
a tool bit reciprocally joined with the primary drive body, the tool bit including a shaft having a first end and a drive head at a second, opposing end of the shaft, the drive head including a drive feature adapted to remain registered with a fastener upon rotation of the tool bit so as to rotate the fastener with the tool bit;
a biasing element joined with at least one of the primary drive body and the tool bit, the biasing element configured to compress under a force as the drive head engages the fastener to allow the tool bit and the drive head to retract toward the primary drive body,
wherein the primary drive body, tool bit and drive head form a spring-loaded drive line that exerts a preselected force on a fastener engaged by the drive head as the drive head rotates and advances the fastener.

9. The controlled force drive element of claim 8 comprising a connector body defining a socket, the connector body slidably joined with the primary drive body, wherein the tool bit is registered within the socket without the tool bit extending into the primary drive body when the connector body is in an extended mode.

10. The controlled force drive element of claim 8,
wherein the biasing element includes a first magnet joined with the tool bit and a second magnet joined with the primary drive body, the first magnet and second magnet repelling one another with a magnetic force so as to urge the tool bit away from the primary body and into an extended mode,
wherein when drive head engages the fastener and the force becomes greater than the magnetic force, the tool bit retracts toward the primary body.

11. The controlled force drive element of claim 10,
wherein the primary drive body includes a housing,
wherein the first and second magnets are located within the housing,
wherein the second magnet is located adjacent the first end of the tool bit.

12. The controlled force drive element of claim 8,
wherein the primary drive body defines a bore and includes an exterior,
wherein the shaft of the tool bit is slidably registered in the bore,
wherein the tool bit includes a biasing element engagement member,
wherein the biasing element includes a coil spring,
wherein the coil spring is disposed around the exterior of the housing,
wherein the coil spring engages the biasing element engagement member to urge the drive head away from the primary drive body.

13. The controlled force drive element of claim 8,
wherein the biasing element is a coil spring,
wherein the coil spring is disposed around an exterior of the primary drive body,
wherein the coil spring is interposed between the primary drive body and the tool bit.

14. The controlled force drive element of claim 8 wherein the tool bit retracts toward the primary drive body at least ½ inch when the biasing element compresses under the force as the drive head engages the fastener.

15. The controlled force drive element of claim 8,
wherein the primary drive body is in the form of a housing,
wherein the tool bit is rigidly and fixedly joined with the housing,
wherein the chuck connector is engaged with the biasing element.

16. The controlled force drive element of claim 8 comprising a connector body joined with the housing, the connector body defining a socket, the first end of the tool bit disposed in the socket.

17. The controlled force drive element of claim 8 comprising;
a connector body, the connector body defining a socket, the connector body forward of the primary drive body along the longitudinal axis, the first end of the tool bit seated in the socket, and
a force indicating element outputting at least one of audible and visual output to inform a user of at least one of the force applied as the drive head engages the fastener and the preselected force, wherein the preselected force is suitable for advancing the fastener into a work piece at a desired advancement rate that avoids damage to the work piece.

18. The controlled force drive element of claim 16 wherein the force indicating element includes a pin that moves in response to the tool bit moving toward the primary drive body, the pin registered in a slot defined by the primary drive body.

19. A controlled force drive element for use with a rotational power tool comprising:
a primary drive body including a chuck connector adapted to join with a chuck of a rotational power tool, the primary drive body including a longitudinal axis, the primary drive body forming a housing having and exterior and defining an internal bore, the housing defining a slot that extends to the exterior;
a secondary drive body including a connector body, the connector body slidably joined with the primary drive body and registered at least partially within the internal bore, the connector body defining a socket, the socket including a retainer;
a tool bit including a shaft having a first end and a drive head at a second, opposing end of the shaft, the drive head including a drive feature adapted to remain registered with a fastener upon rotation of the tool bit so as to rotate the fastener with the tool bit, the first end of the shaft the tool bit registered within the socket, without the tool bit extending into the primary drive body when the connector body is in an extended mode, the retainer of the socket engaging the tool bit to retain the tool bit in the socket and associated with the connector body, the tool bit and connector body being generally immovable relative to one another when joined;
a biasing element adapted to urge the secondary body to an extended mode, the biasing element compressible under a force to allow the secondary body to retract to a retracted mode while advancing a fastener with the drive element;
a pin joined with at least one of the connector body and the tool bit, the pin registered in the slot defined by the housing and slidable within the slot when the secondary body retracts to a retracted mode;
wherein the biasing element is compressible under the force so that as the biasing element compresses, the drive head of the tool bit moves toward the primary drive body and the secondary drive body retracts to the retracted mode, and so that as the biasing element decompresses, the drive head moves away from the primary body and the secondary drive body extends to the extended mode;
wherein the housing includes a primary force indicating element on the exterior adjacent the slot,
wherein the pin aligns with the primary force indicating element when the secondary drive body retracts to the retracted mode under the force, thereby indicating to a user that a preselected force suitable for advancing the fastener has been achieved,
wherein the primary drive body, secondary drive body, tool bit and drive head form a spring-loaded drive line that exerts the preselected force on the fastener engaged by the drive head as the drive head rotates and advances the fastener.

20. The controlled force drive element of claim 19,
wherein the biasing element is a coil spring disposed in the internal bore of the housing,
wherein the coil spring directly engages the connector body, but not the tool bit.
